(19) United States
(12) Patent Application Publication
(10) Pub. No.: US 2006/0144511 A1
(43) Pub. Date: Jul. 6, 2006

(54) Process and a press for laminating substrates carrying powder ink

(75) Inventor: Edmond Abergel, Paris (FR)

Correspondence Address: LOWE HAUPTMAN BERNER, LLP, 1700 DIAGONAL ROAD, SUITE 300, ALEXANDRIA, VA, 22314, US

(73) Assignee: MGI France, Ivry sur Seine (FR)

(21) Appl. No.: 11/315,596

(22) Filed: Dec. 23, 2005

(30) Foreign Application Priority Data
Dec. 24, 2004 (FR) 04 13874

(51) Int. Cl. B32B 38/14; B32B 37/00; B32B 37/06; B30B 15/34; B32B 37/10

(52) U.S. Cl. 156/277; 156/182; 156/311; 156/323; 156/358; 156/359; 156/583.1; 156/537

(57) ABSTRACT

A press for documents or patterns printed with powder ink on a plastic or paper substrate has a controller for applying pressure and heat to one or more printed substrates or to a stack of plural printed substrates. The controller includes heating plates that cause the applied pressure and heat to be such that the pressure and temperature of the substrate(s) or stack has at least one specified pressure and temperature, in accordance with specified cycles. During the cycles, the controller varies the applied temperature and pressure for a specified duration. The stack includes at least one plate for separating the printed substrate(s) while the heat and pressure are applied. The heating and separating plates include finished surfaces for providing a finish to the printed document. A protective film is located between the finished surfaces and printed faces of the substrates while the pressure and heat are being applied.

### RELATED APPLICATION

The present application is based on, and claims priority to French Application Serial Number 04 13874, filed Dec. 24, 2005, the disclosure of which is hereby incorporated by reference herein in its entirety.

### FIELD OF THE INVENTION

The invention concerns a lamination process and apparatus for substrates carrying powder ink.

### BACKGROUND ART

The advantage of printing with powder ink is its flexibility of adaptation, but one of its disadvantages is the difficulty of fixing the printing, in a durable manner, on documents which are subjected to demanding conditions of use, such as wear, UV radiation, etc.

A first objective of the invention is to propose a process for the lamination of a paper or plastic substrate carrying powder ink that overcomes the disadvantages of prior art.

### SUMMARY OF THE INVENTION

This objective is attained by a process which includes at least the following stages:

printing of the image onto one face of a substrate, by printing with powder ink,

protection by a film of the elements in contact with the print,

application of pressure and temperature according to a particular cycle on the printed substrate or on a stack of printed substrates so as to achieve glazing of the ink deposited on the substrate or the stack of substrates.

According to another particular feature, the substrate printed on one face is assembled with another substrate so that by affixing both substrates by their unprinted sides onto a third substrate, a final product is obtained, wherein the final product is printed on both sides with a determined thickness constituting a stack, and then at least one stack is placed between two plates, and laminated with a controlled pressure and temperature so as to achieve a welding or merging of the substrates.

According to another particular feature to achieve glazing of the ink, the process includes:

a stage for applying a determined pressure (Pi) to the substrates,

a stage of temperature increase of the substrates to a fixed temperature setpoint Ci,

the establishment of one (Ci) or more (Ci, C′i) temperature steps such that the temperature of the substrates is maintained at a constant setpoint for a specified period (Ti, T′i respectively),

a continuous adjustment of the pressure with one (Pi) or more (Pi, P′i) possible pressures for at least a second specified period (ti, t′i respectively) while the substrate temperature is maintained at the constant setpoint,

a stage for cooling the substrates to a specified temperature,

a stage for removal of the pressure.

According to another particular feature, at least one setpoint is aimed at reaching a temperature that is equal to or greater than 50° C.

Another objective of the invention is to provide a press for any type of substrate paper or plastic, printed by printing with powder ink that overcomes the disadvantages of prior art.

This objective is attained by a press capable of printing documents or patterns on a plastic or paper substrate using printing with powder ink. The press includes a controller for applying at least one specified pressure and temperature, in accordance with specified cycles, with variation of the temperature and/or the pressure, for a specified duration, to one or more printed substrates or to a stack comprising a plurality of printed substrates.

### BRIEF DESCRIPTION OF THE DRAWINGS

Other features and advantages of this present invention will appear more clearly on reading the following description, provided with reference to the appended drawings, in which:

FIG. 1 represents the press employed to implement the process according to the invention;

FIG. 2 represents the temperature and pressure cycle implemented by the process;

FIG. 3(a) represents a stack of substrates to form a finished product with a printed document on both of its faces, as shown in FIG. 4(a);

FIG. 3(b) represents a document created on a single printed substrate;

FIG. 4(a) represents a document printed on both faces and with no overlay;

FIG. 4(b) represents a document printed on one face only and with no two-sided overlay;

FIG. 5(a) represents a document printed on both faces with overlay on both faces, and FIG. 5(b) represents a document printed on one face only and with an overlay on a single face.

### DETAILED DESCRIPTION OF THE DRAWINGS

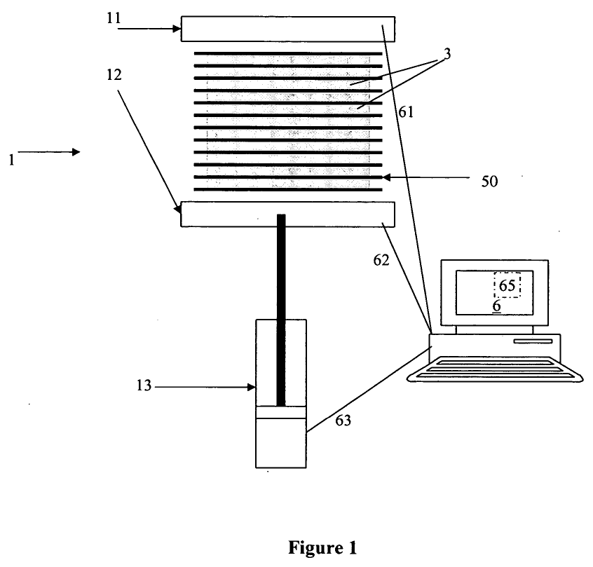

Each of assemblies (3), FIG. 1, includes, for example, a substrate (31, 32, 39, FIG. 3) of plastic or paper on which are printed documents (33, 34, 40) or patterns. The documents or patterns are printed on one face of substrate (31, 32, 39) by a digital laser printer and are then collected in an out tray, and then stacked with separation plates (50), FIG. 1, between each assembly (3) with a view to executing a process called lamination of the stack by using a press (1), including heating plates 11, 12 (FIGS. 1 and 3).

In another embodiment, the press (1) applies a treatment to assembly (3), regardless of whether the assembly (3) is located or not located between two separation plates (50). In a non limitative way, one assembly (3) or a plurality of assemblies (3) are placed side by side in the same press (1) during a lamination operation.

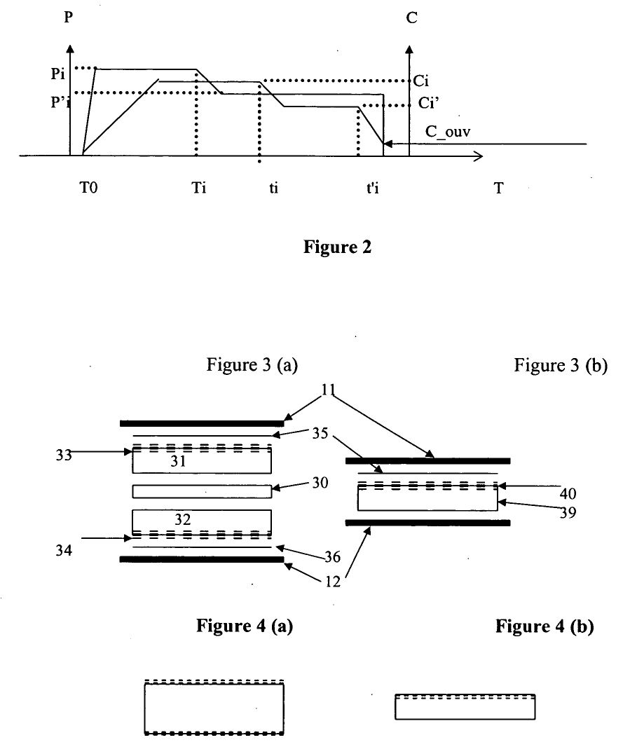

The lamination process is performed with a press (1), such as that shown in FIG. 1, by controlling the pressure and the temperature, in a series of cycles (Ci, Ti, C′i, T′i; Pi, ti, P′i, t′i) such as those represented in FIG. 2, to treat one assembly (3) or a plurality of assemblies (3) or a stack of assemblies (3) of substrates (31, 32, 39) placed between plates (50). The separation plates (50) can be metal or any other material such as Capton®, PTFE or silicon-treated glass fibre, in order to obtain mechanical and thermal characteristics that are suitable for the process.

The FIG. 3(b) shows an assembly (3) composed of a substrate (39) carrying an ink layer (40); the substrate is located between the heating plates (11, 12) of the press (1). A film (35) to protect the recto of substrate 39 is placed between the ink layer (40) and the upper heating plate (11).

FIG. 3 (a) represents an assembly (3) comprising two substrates (31, 32) associated with a recto ink layer (33) and a verso ink layer (34) and comprising an intermediate substrate (30). The intermediate substrate (30) has a defined thickness which allows different document formats of a specified thickness to be produced. The thickness of the final product depends on the thickness of the intermediate substrate (30)

The substrates (31, 32), applied to opposite faces of substrate (30), respectively form the recto and the verso of the final document. The intermediate substrate (30), which is pre-affixed or is of such a nature as to bring about welding or adherence during lamination, can be inserted between the two printed substrates (31,32) which are joined to substrate (3) by their unprinted faces. The intermediate substrate (30) is, for example, a thin support or a plate containing a metallic structure, such as an antenna or a plate, containing an electronic device such as a microcircuit. A film (36) that protects the verso is placed between the verso ink layer (34) and the lower heating plate (12).

In another embodiment a printed substrate is applied to a substrate which is not printed to obtain a product printed on a single face and of a determined thickness.

This operation of laminating the printed substrate or an assembly (3) of substrates (30, 31, 32) or a stack of a several assemblies (3), results in glazing of the toner or of the powder ink (33, 34 in FIG. 3a; 40 in FIG. 3b) that forms the printed parts of substrates 31, 32 and 39. The toner comprises, for example, carbon amalgamated by applying a determined pressure and temperature.

The protective films (35, 36), placed on the printed faces (33, 34 and 40) of the substrates before the lamination procedure can be single-use or reusable. The films are inexpensive, and can be produced for these both applications.

In an embodiment, a single protective film (35, 36) is placed between substrates 31, 32 and end plates 11, 12, respectively. The films (35, 36) stay in place on the final product to protect the final product during storage.

The final product is without a protective layer (has no overlay) and with recto-verso printing as illustrated in FIG. 4 (a), or with printing on one face (40) of the substrate (39) as shown in FIG. 4 (b).

In the cases of FIGS. 4(a) and 4(b), the film material is chosen primarily to allow good thermal transfer for glazing of the ink or toner and secondarily to protect the heating plates (11, 12) of the press (1) or the protective plates (50) from staining by the ink on the substrates. For example, protective films are formed of polypropylene or polypropylene and other similar chemical components. The chemical composition of films (35, 36) and their narrow thickness of, for example, a few micrometers, causes the films (35, 36) to have a surface finish corresponding to the finishes of the heating plates (11, 12) of the press (1) or of protective plates (50).

In an embodiment, a protective film (35, 36) is removed from a face of substrate (31, 32) after a lamination and an overlay (42, 41) is then bonded or stuck by pressure on the exposed face of the final product.

In another embodiment, the protective films (35, 36) are fixed to the plates (11, 12) of the press (1) or to the protective plates (50) and are saved for further use after each lamination operation. An overlay can be applied on each face of the final product, after the lamination operation.

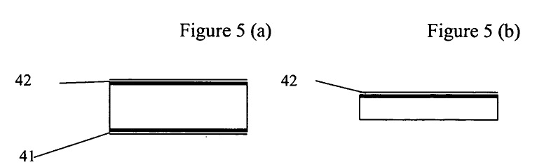

The document then has an overlay on both faces as illustrated in FIG. 5(a) or on a single face as in FIG. 5(b).

The material of the films (35, 36) must (a) have high thermal conductivity, (b) support temperatures of the order of 200° C. to allow glazing of the ink or toner (33, 34, and 40) and (c) provide adequate protection for protective plates (50). Glazing of the ink or toner occurs at a temperature of at least 50° C. This protection the films provide to plates (50) prevents staining of plates (50) by transfer of ink to the metal plates (50), and depending on the choice of film, prevents adherence of the heating plates (11, 12) of the press (1) and/or of protective plates (50) to the substrates.

The plates (50) act as intermediate protective plates between each assembly (3) of substrates as illustrated in FIG. 3a or FIG. 3b, to form a stack to be treated in a single lamination procedure. The number of assemblies (3) to be treated can vary from 1 to n, and can necessitate the stacking of 2 to n+1 intermediate plates (50), which are placed in a maintaining structure such as a “drawer”. These drawers are then positioned between the heating plates (11, 12) of the press (1).

In a non limitative way, the press can be used to treat from 1 to n drawers placed between 2 to n+1 heating plate.

A drawer for maintaining a stack or an assembly (3), such as previously described, is placed between two heating plates (11, 12) whose temperature is controlled by commands (61, 62) received from a computer system (6) so as to execute temperature cycles (Ci, Ti; C′i, T′i) such as that shown in FIG. 2. The applied temperature cycles, referring to FIG. 2, comprise a first temperature set point which causes a first relatively high temperature to be applied to the heating plates (11, 12) for a time Ti, and then a second temperature set point (C′I) which causes a second, lower temperature to be applied to the plates for a time T′i. These heating plates (12) transmit the heat to one or a plurality of stacks composed of assemblies (3) and plates (50). In the same manner, plates (11, 12) can transmit the heat to an assembly that may or may not include protective plates (50).

One or both of plates (11, 12) of the press (1) are moved by at least one hydraulic jack (13) controlled by the computer system (6), in order to put the assemblies (3) under pressure and to apply the pressure cycles (Pi, ti and P′i, t′i respectively) to the assemblies (3). The pressure cycles (Pi, ti and P′i, ti) are such as are necessary for correct execution of the operation in sequence with the temperature.

A cycle, which typically lasts for some minutes, with control of temperature and pressure, is then established (FIG. 2). This is the lamination procedure. The graph shown on FIG. 2 represents different temperatures (C) and different pressures (P) that are applied by heating plates 11, 12 during the lamination process.

As a result of this lamination procedure, finished products are obtained; the finished product have faces on which documents or patterns are printed with toner or powder ink, which is glazed and with or without a protective layer or overlay.

The lamination cycle is executed by the press (1) on a stack of assemblies (3) or on a single assembly (3) having the structure of FIG. 3(a) or that of FIG. 3(b) or a combination of these two structures. The cycle is illustrated in FIG. 2 as including:

a stage for applying a determined constant pressure (Pi) to the substrates,

a stage of raising temperature to the fixed temperature setpoint Ci during which pressure Pi is applied,

one (Ci) or more (Ci, C′i) constant temperature stages at the setpoint for at least a specified period (Ti, T′i respectively),

continuous adjustment of the pressure with one (Pi) or more (Pi), P′i) possible changes of pressure for at least a second specified period (ti, t′i respectively) during the constant temperature stage,

a stage for cooling the substrates to a specified temperature,

a stage for removal of the pressure.

The important points are the applied pressure is set to a predetermined constant value during the temperature rise and can be varied most of the time while the temperature is constant. The system provides simultaneous control of the pressure and the temperature; the applied temperature and the applied pressure are controlled and can vary during a single lamination operation. A lamination comprises, for example, a rise of temperature until a first temperature step (Ci) is reached, combined with the application of a specified pressure.

In another embodiment, a lamination comprises the application of a specified pressure (P′i) and a transition from a first temperature step (C′i) to a second temperature step (C′i).

In another embodiment, a lamination comprises the application of a specified temperature (Ci) and the transition from a first step (Pi) of pressure to a second step (P′i) of pressure.

A lamination comprises, in a non limitative manner, an increasing pressure stage and/or an increasing temperature stage and/or a removal pressure stage and/or a decrease of temperature stage. These different stages can be combined or repeated.

The press control system regulates the other important parameters which are:

the speed of temperature rise and the value of the temperature setpoint and,

the period or periods for which the temperature setpoint is held constant.

As an example, the cycle can include the application of a pressure Pi for a time Ti corresponding at least to the phase of the temperature increase specified by setpoint Ci, followed by a phase of temperature regulation for a time ti.

During this temperature regulation phase, the applied pressure can be changed to another value P′I, which is higher or lower than the first pressure value Pi, with this second value being held for a time T′I, during which the temperature is changed to a second value determined by a second setpoint C′i applied for a time t′i, before being changed to a cooling temperature and ending application of the pressure to the substrate or to the pile of stacks.

These different parameters of setpoint, duration, pressure and temperature are adjusted according to the substrate on which the document is printed, and determined from a table (65) stored in the press control system (6), depending on the type of substrate to be laminated, as shown in Table 1 of the appendix. Table 2, of the appendix contains different examples of setpoints for temperature, pressure and duration, depending on the substrate materials. The application of a specified pressure and of a specified temperature, for a specified duration, causes proper glazing of the toner which is bonded to the substrate. The pressures or the temperatures are applied by one step or by a plurality of different steps.

The innovation concerns lamination with a protection of the plates (11, 12 and 50) for applying heat and pressure to the documents in order to ensure correct glazing and very good penetration of the ink into the material of the substrate.

When these plates (11, 12 and 50) are metal, they are protected by a special film that separates them from the printed face of the substrate.

One of the difficulties concerns the choice of film (35, 36).

The film (35, 36) must be non-adhesive and of a specific thickness, of the order of 5 to 100 microns for example, which renders it permeable to the surface finish of the plate (50) used for the lamination procedure, in order to provide a reproduction of this surface finish on the printed document or pattern. This allows one, for example, to obtain a gloss, satin or mat finish depending on the surface finish of the plate (50) that has been polished or sanded. In addition to protecting the plates (11, 12 and 50) used in the lamination process against any transfer of ink, the film (35, 36) has other objectives, depending on its composition.

The printed image thus processed by lamination of the substrate has good resistance to UV radiation, and has very good resistance to free air and bad weather when the substrate is made of plastic.

When the film is joined and affixed to protective plate (50) or to the heating plates (11, 12) of the press (1) or obtained by a coating process, this film has anti-adhesive qualities. In this case, the film allows glazing of the ink while avoiding the transfer of ink, to facilitate the cleaning and protection of the plate. The plates (50) can be made, for example, from PTFE, capton, silicon-treated glass fibre, or any other anti-adhesive material with good thermal conductivity, good mechanical strength, and that can cope with temperatures above 200° C.

The substrates associated with protective layer (41, 42), can be a simple or holographic overlay, stuck or welded to the substrate after lamination.

These lamination processes, with a choice of the films or plates specific to glazing of the digital print, can also apply to all other offset printing processes, such as screen printing, offset printing etc . . .

It is preferable to have a plate at each end of a stack composed of plates and substrates in order to obtain the same surface state on all the glazed documents.

It should be obvious to people who are well versed in these techniques that this present invention allows implementation by several other specific means without going outside of the area of application of the invention as claimed. As a consequence, the methods of implementation mentioned here should be considered to be given by way of illustration, but with freedom to modify them within the limits indicated by the scope of the attached claims.

### Appendix

TABLE 1

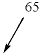

| | | | | Pressure | Length | Length |
|---|---|---|---|---|---|---|
| | | Length of | Pressure | P′i | of first | of second |
| | Temp. | temperature | (Pi) during | During 1st | pressure | pressure |
| Type of | setpoints | steps, Ti, | temperature | temperature | step | step |
| Substrate | Ci, C′1 | T′i | rise | step | Pi | P′i |
| Paper | C1, C′1 | T1, T′1 | P1 | P′1 | t1 | t′1 |
| PVC | C2, C′2 | T2, T′2 | P2 | P′2 | t2 | t′2 |
| PET | C3, C′3 | T3, T′3 | P3 | P′3 | t3 | t′3 |
| Polycarb | C4, C′4 | T4, T′4 | P4 | P′4 | t4 | t′4 |
| Other . . . | Ci, C′i | Ti, T′i | Pi | P′l | ti | t′i |

TABLE 2

| | PALIER 1 | | PALIER 2 | |
|---|---|---|---|---|
| Type of | Pressures et | Durations | Pressures and | Durations |
| Substrate | Temperatures | applied | Temperature | Applied |
| Paper | | | | |
| Pressures | P1min | TP1min | P′1min | TP′1min |
| | P1max | TP1max | P′1max | TP′1max |
| Temperatures | C1min | TC1min | C′1min | TC′1min |
| | C1max | TC1max | C′1max | TC′1max |
| PVC | | | | |
| Pressures | P2min | TP2min | P′2min | TP′2min |
| | P2max | TP2max | P′2max | TP′2max |
| Temperatures | C2min | TC2min | C′2min | TC′2min |
| | C2max | TC2max | C′2max | TC′2max |
| PET | | | | |
| Pressures | P3min | TP3min | P′3min | TP′3min |
| | P3max | TP3max | P′3max | TP′3max |
| Temepratures | C3min | TC3min | C′3min | TC′3min |
| | C3max | TC3max | C′3max | TC′3max |
| Polycarbonate | | | | |
| Pressure | P4min | TP4min | P′4min | TP′4min |
| | P4max | TP4max | P′4max | TP′4max |
| Temepratures | C4min | TC4min | C′4min | TC′4min |
| | C4max | TC4max | C′4max | TC′4max |

1. A process of laminating documents printed with ink in powder form on a paper or plastic substrate, the method comprising:
printing an image with powder ink onto one face of a substrate;
glazing the ink deposited on the printed substrate or a stack of printed substrates by applying pressure and heat to the printed substrate or the stack of printed substrates;
at least one of the applied pressure and temperature of the applied heat being changed during the glazing step; and
preventing contact between printed faces of the substrate or stack of substrates and structures of a mechanism that applies the pressure and heat by providing a film between the structures and the printed faces of the printed substrate or stack of printed substrates during the glazing step.

2. A process according to claim 1, wherein a substrate having printing on one face is assembled with a second similar substrate having printing on one face by attaching the unprinted sides of the first and second substrates to a third intermediate substrate to obtain a final product that is printed on both sides, forming a stacked assembly of the finished products and laminating the assemblies, and then placing at least one of the assemblies between two plates with a controlled pressure and temperature to achieve joining of the first, second and intermediate substrates.

3. A process according to claim 2, wherein the process includes:
a stage that applies a determined pressure to the substrates,
a stage of applying heat so the temperature of the substrates rises to a fixed temperature setpoint;
establishing one or more additional temperature setpoints at temperature steps, holding of the setpoints for at least a first specified period,
continuously adjusting the pressure so the pressure has one or more changes for at least a second specified period during at least one of the temperature steps,
a stage for cooling the substrates to a specified temperature,
a stage for removal of the pressure.

4. A process according to claim 3, wherein at least one setpoint is equal to or greater than 50° C.

5. A process according to claim 4, wherein the pressure removal stage is followed by removal of the protective film.

6. A process according to claim 2, wherein the intermediate substrate includes an active or passive electronic component.

7. A process according to claim 3, wherein the removal stage is followed by a stage applying a permanent protection layer.

8. A press for documents or patterns printed with powder ink on a plastic or paper substrate, comprising a controller for applying pressure and heat to one or more printed substrates or to a stack of plural printed substrates, the controller being arranged for causing the applied pressure and heat to be such that the pressure and temperature of the substrate(s) or stack has at least one specified pressure and temperature, in accordance with specified cycles, with variation of at least one of the temperature and the pressure, for a specified duration.

9. A press according to claim 8, wherein the controller includes heating plates that are arranged to be driven toward each other and the substrate(s) or stack for applying the heat and pressure to the substrate(s) or the stack, the stack including plates for separating the printed substrates.

10. The press of claim 9 wherein the heating plates are arranged for applying the heat and pressure to the stack, the stack including at least one plate for separating the printed substrate(s) during the application of the heat and pressure by the heating plates.

11. A press according to claim 9, wherein at least one of the (a) heating plates and (b) the separating plates includes at least one finished surface for providing a finish to the document, a protective film located between the finished surfaces while the pressure and heat are being applied, the film being made of material that (a) can cope with the temperatures encountered by the plates during application of the heat and pressure without adhering to the heating plates or to the separating plates, and (b) has a high thermal conductivity to provide heating of the substrates, the film thickness being sufficiently narrow to provide it with permeability to the finished surface of the separation plate or of one of the heating plates in order to provide a replica of the finished surface on the document.

12. The press of claim 11 wherein the film must cope with temperatures of the order of 200° C.

13. A press according to the claim 9, wherein the controller is arranged to control variable setpoints of temperature and pressure as a function of time during a single pressing operation.

14. A press according to claim 13, wherein the values of the setpoints depend on the material of the substrate and are stored in a memory of the controller.

15. A press according to claim 11, wherein the protective films are fixedly attached to the plates.
